(19) United States
(12) Patent Application Publication
(10) Pub. No.: US 2013/0036150 A1
(43) Pub. Date: Feb. 7, 2013

(54) METHOD OF TRANSFERRING DATA TO A FUNCTIONAL APPLICATION AND A USER TERMINAL THERETO

(71) Applicant: Ilkka KEISALA, ESPOO (FI)

(72) Inventor: Ilkka KEISALA, ESPOO (FI)

(73) Assignee: TELIASONERA AB, Stockholm (SE)

(21) Appl. No.: 13/560,269

(22) Filed: Jul. 27, 2012

(30) Foreign Application Priority Data
Aug. 2, 2011 (EP) 11176330.6

(51) Int. Cl. G06F 15/16

(52) U.S. Cl. 709/201

(57) ABSTRACT

The invention concerns in general the technical field of transferring data to a functional application and a utilization of resources of mobile communication network in the context of functional applications. A method according to the invention for delivering data dedicated to a functional application comprises at least the following steps: receiving a message containing data dedicated to a functional application and transmitted at least partly over a mobile communication network in a predetermined message form, interpreting the data in the message, and instructing a functionality of the functional application on a basis of the data in the message. The invention also concerns a user terminal and a system for implementing at least part of the functionalities of the method and related into it.

### TECHNICAL FIELD

The invention concerns in general the technical field of transferring data to a functional application. Especially the invention concerns a utilization of resources of mobile communication network in the context of functional applications.

### BACKGROUND OF THE INVENTION

Modern operating systems in electronic devices have enabled the development of network connected functional applications. The most popular ones are online email applications as well as Internet browser. Lately, the trend has been to introduce small and light-weight functional applications on top of the operating system, which are known with a term of ‘widgets’.

A wide variety of functional applications available and one can find such an application basically for any need. A simple example of a functional application is a news widget, which e.g. brings the headlines of the news on the desktop so that a user can see at a glance, what is happening. Widgets can be categorized according to their usage. The most popular category is desktop widgets, which are virtual tools that provide single-purpose services such as showing the user the latest news or the current weather among other things. Second category is mobile widgets which are like desktop widgets, but meant for a mobile phone. Mobile widgets can optimize the features of the widget applications to a mobile phone. Third known category is web widgets. Usually the browsers are used as widget engine infrastructures i.e. the applications run on top of the Internet browser. Also other widget categories are known, but the above mentioned are most common ones.

One typical feature of the widgets is that they can be developed quite easily by users since the interface to the operating system is open in most of the cases. Most of the widgets can be created with a few images and with only a limited number of lines of XML/JavaScript/VBScript source code.

Lately, the number of functional applications has increased dramatically especially in the field of smart phones and their operating systems. The competition of the operating systems in smart phones has culminated into the development of applications i.e. widgets. For example, several market places i.e. so called stores offer smart phone users the possibility to acquire functional applications for their mobile terminals for free or against a moderate payment.

As described the functional applications offer users an easy access to information they desire. The piece of information, such as news headline, is normally downloaded to the terminal over IP (Internet Protocol) by the widget application and the downloading is triggered by widget application. This kind of environment is generally known as a client—server architecture, where the application (i.e. client) takes care of the connection towards the network (application server) and downloads or sends data from or to the network. Downloaded data for widget applications is typically transferred as data packets through data subscriptions of mobile users. Alternatively, a traditional circuit switched network providing data connection service is suitable to widget type applications due to limited amount of data required by widgets.

The functional application server locates normally in Internet and serves the functional applications. For instance, the functional application server is storage for functional applications so that users can download the application from there. Additionally or alternatively, the functional application server can serve as a storage, or middleware, for the data for the functional applications. It can store e.g. the data for the news widget so that the news application in the terminal can download the news information from the server. It can also operate as a linking server for functional applications and service providers so that the functional application in the user terminal connects to a same application server for acquiring an address to another server comprising actually the acquired data.

There are several drawbacks of prior art solution relating to the operation of functional applications and especially to the downloading of information for the functional application. If there is no IP based network available at all, e.g. IP based network is down, the functional application is not capable of receiving any information for its needs. As a result, the user gets very unsatisfied user-experience.

Another drawback is that by using the typical mode of data transfer of a functional application i.e. the functional application connects to the application server and downloads data from there, it does not meet all security requirements for specific functional applications.

### SUMMARY OF THE INVENTION

An objective of the invention is to present a method and a user terminal for utilizing a message in a functional application sent from a functional application server to a terminal over a mobile communication network.

The objectives of the invention are achieved by transmitting the notification message from a functional application server to a terminal over mobile communication network by utilizing the predetermined message form in transmission.

A method according to the invention is characterised by the steps recited in the characterising part of the independent claim directed to a method.

A user terminal according to the invention is characterised by the features recited in the characterising part of the independent claim directed to a user terminal.

A system according to the invention is characterised by the features recited in the characterising part of the independent claim directed to a system.

According to an embodiment of the invention the terminal and the functional application in the terminal are capable of receiving a message over mobile communication network.

According to an embodiment the message is a SMS (Short Message Service) or as a MMS (Multimedia Messaging Service).

According to a further embodiment of the invention the structure of the received message is recognized and the content of the message is interpreted in the terminal. Based on the interpretation of the message the functionality or configuration of the functional application is instructed according to the content of the message.

According to some embodiments of the invention the message is transmitted as a so called invisible message for the user.

According to some further embodiments of the invention the message is interpreted in a smart card coupled to a user terminal and the smart card is arranged to give instructions relating to the functionality of the functional application.

The exemplary embodiments of the invention presented in this patent application are not to be interpreted to pose limitations to the applicability of the appended claims. The verb “to comprise” is used in this patent application as an open limitation that does not exclude the existence of also unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF DRAWINGS

FIG. 1 illustrates a prior art solution in the context of functional application,

FIG. 2 illustrates a principle according to an embodiment of the invention,

FIG. 3 illustrates a method according to an embodiment of the invention, and

FIG. 4 illustrates a block diagram of a user terminal according to an invention.

### DETAILED DESCRIPTION OF THE INVENTION AND ITS ADVANTAGEOUS EMBODIMENTS

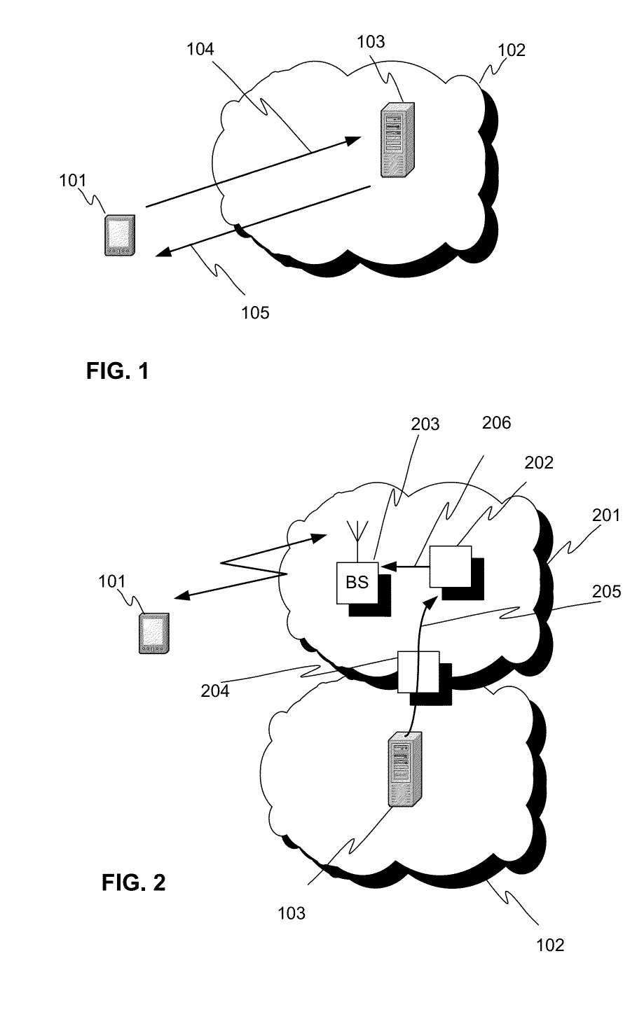

FIG. 1 illustrates a traditional arrangement for functional applications where the functional application residing in a user terminal 101 sends a request 104 for data over IP (Internet Protocol) network 102. The functional application server 103 locating in the IP network 102 receives the request 104 and in response 105 to the request transmits the required data to the user terminal 101. The user of the terminal gets the required service, e.g. he or she can read news headlines from his or her terminal as long as there is IP network available. In the prior art solution the transmission of the data specifically originates from the request of the functional application residing in the terminal.

FIG. 2 illustrates an embodiment according to the invention where the functional application server 103 sends a message to the functional application residing in the user terminal. In a method according to the invention the functional application server 103 establishes a connection to client by pushing the data without client pull—request using non-IP connection like a connection over 2G or 3G or 4G network. In other words, the functional application server 103 is configured to send a message over a mobile communication network 201. The functional application server 103, locating in IP network 102, is capable of composing a predetermined message form, such as a SMS or a MMS, for mobile communication network 103.

With the term of predetermined message form it is meant any such message, which can be sent over a mobile communication network. Examples of such message forms are short messages (SMS) and multimedia messages (MMS), which are defined in a corresponding telecommunication standard. After composing the message the functional application server is configured to send the message either directly or indirectly over mobile communication network. If the functional application server is capable of sending the message directly, it comprises typical radio access means, such as a radio modem, for being connected to the mobile network directly and utilizing the radio resources there. If the functional application server 103 is configured to send the message indirectly, the functional application server is connected to a first network, such as IP network 102, which is further interworking with a mobile communication network 201. Thus, the server is configured to compose a message and deliver it to the first network, such as IP network, which delivers the message 205 further to the mobile communication network. The mobile communication network 201 delivers the message from the core network elements 202 via radio network elements, e.g. a base station 203, to the user terminal 101. If needed, for example, the interworking element 204 between said first network 102 and the mobile communication network 103 is arranged to modify the message so that it complies with the requirements in mobile communication network. In FIG. 2 it is illustrated some network elements in the mobile communication network, such as a base station 203 and some core network element 202 enabling the transmission of a message from the functional application server 103 to the user terminal 101 at least partly over a mobile communication network 201. It is noted here that FIG. 2 does not comprise all necessary elements in either of the networks 102, 201 to accomplish the transmission of a message.

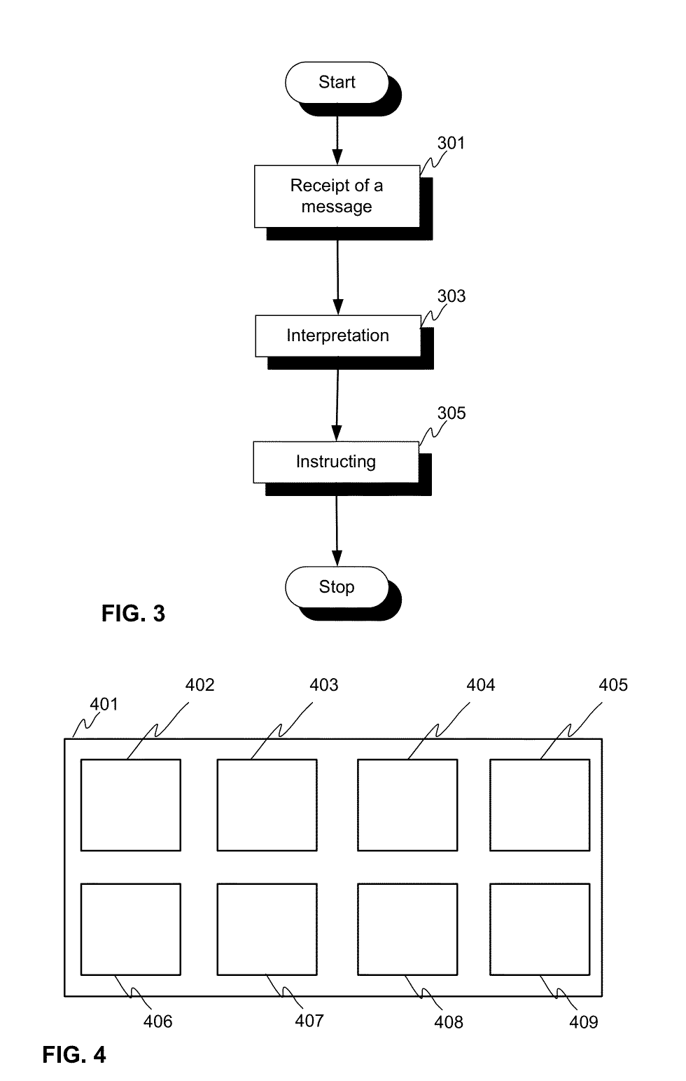

FIG. 3 illustrates a simplified flow chart of the method according to the invention. In the first step the message sent by the functional application server over mobile communication network is received. The receipt of the message 301 is done by means of radio communication means implemented in the user terminal. In the next step of the method according to the invention the data in the received message is interpreted 303. The interpretation may comprise e.g. recognizing the structure of the message i.e. if there is a specific structure in the message so that it can be recognized on the basis of the structure that the message contains data dedicated to the functional application. Furthermore, the interpretation comprises a way to analyze the data so that on the basis of the data an instruction can be given to the functional application 305, as disclosed in the method step in FIG. 3. The instruction is typically related to a functionality of the functional application.

The instruction related to the functionality of the functional application in this context shall be understood as a data dedicated to the functional application and delivered further to the user. Alternatively or in addition, the instruction shall be understood as a data related to configure and / or update the functional application itself.

Functional applications residing in the memory of a user terminal and run by means of processing means of the user terminal may receive multiple types of messages from the functional application server. According to some embodiment of the invention the message may relate to the desires of the user of the terminal, i.e. being content for the application such as news headline, or it can relate to the application itself. The application related message can be e.g. an update data for updating the application or configuration data for configurating application to operate in a desired manner. It can be that any of these types of messages can be so called structured or un-structured message.

Structured message means that it is agreed in advance, in which form the message is composed. For example paragraphs in the message are ordered in a specified sequence, each paragraph can be characterized by identifier and containing information in free form. Furthermore, many times structured message is composed so that the message is not understandable by the user. Additionally, the message can be encrypted according to the requirement of provided service.

Instead, an un-structured message means that there are no pre-determined identifiers for the data, so data can be in any order, e.g. plain text message or even an executable file are examples about the unstructured messages. Such unstructured messages may contain visible and invisible parts to the user.

According to some embodiments of the invention the message is delivered as a structured message to the functional application residing in the user terminal. According to some other embodiments of the invention the message is delivered as an un-structured message to said functional application. According some further embodiments of the invention some specific messages are delivered in a structured form and some other specific messages are delivered in an un-structured form. For example, an update data for the functional application is delivered in structured form, but the functional data dedicated to the user, e.g. news headlines, is delivered in un-structured manner. By means of this sort of arrangement the security of the operation of the functional application can be managed. The functional application residing in the user terminal is configured to recognize if the data received is structured or un-structured and based on the recognition utilize the data accordingly. The recognition can be arranged with software to be run in processing means of the terminal.

Supplementary functions are applied if the characteristics of services require advanced implementations. For example, such features are utilizing the location info of users and retrieval of user profile data for further modifying the functional application based service. User profiles also contain added parameters which are available for developing services in large variety of implementations.

For instance, location sensitive functional applications may provide directory info about surrounding commercial services, traffic info, weather forecast etc. Profiles may contain the preferred services subscribers wish to use. Moreover, the user profile may contain information on the desired communication channel. For example, a certain functional application may operate in a so called normal manner i.e. utilizing the typical client—server architecture until a predetermined event, e.g. relating to information received from the server. In such a situation the functional application is configured to check further instructions from a user profile, which instructions indicate that the typical client-server operation is to be stopped. Furthermore, the instruction in the user profile may further define that after a predetermined period of time of non-operating client—service operation, a predetermined message, such as SMS, is sent over a mobile communication network to the terminal and thus to the functional application residing in the terminal. The predetermined message may e.g. update the functional application or function of it and/or contain information to be displayed to the user of the mobile terminal.

According to an embodiment of the invention a message relating to a functional application in a mobile terminal is sent to a user terminal over mobile communication network, which terminal is configured to receive the message. The message is sent by a functional application server. The message is transmitted over the mobile communication network with a predetermined message type such as a short message (SMS) or as a multimedia message (MMS) which are also so called standardized message types within some mobile communication technologies.

Depending on the functional application type and/or its requirements the sophisticated classes of the mentioned predetermined message forms can be used. For example, for a short message service (SMS) it is developed the following alternative message classes to be used in the mobile communication network:
Class 0: Indicates that this message is to be displayed on the mobile terminal immediately and a message delivery report is to be sent back to the short message service centre. The message does not have to be saved in the mobile terminal or on the subscriber identity module (SIM) card (unless selected to do so by the mobile user).
Class 1: Indicates that this message is to be stored in the memory of the mobile terminal or the SIM card (depending on memory availability).
Class 2: This message class is Phase 2 specific and carries SIM card data. The SIM card data must be successfully transferred prior to sending acknowledgement to the short message service centre. An error message will be sent to the short message service centre if this transmission is not possible.
Class 3: Indicates that this message will be forwarded from the receiving entity to an external device. The delivery acknowledgement will be sent to the short message service centre regardless of whether or not the message was forwarded to the external device.

The mentioned classes above identify the message's importance as well as the location in the user terminal (with UICC; Universal Integrated Circuit Card) where the message shall be stored. For example, in many occasions the mentioned class 1 is advantageous for functional applications in the mobile terminal due to its character that the message is stored in the memory of the user terminal or UICC card. In some examples of the method of the invention the functional application is configured to recognize the storing of the message and retrieve the data in the message from the corresponding memory element.

In case of a receipt of a structured message, it is preferred that the message is invisible to the user. The reason is that if a user of the terminal receives and reads a message that he or she does not understand, he or she may delete the message immediately even if it is dedicated to the functional application and not to the user as such. Generally speaking, a receipt of messages dedicated to a functional application is advantageously not recognizable by the user.

Similarly, multimedia message (MMS) standard has different message classes which enable different type of transmission of messages to the functional application residing in the user terminal.

Utilization of multimedia message in the context of the current invention enables even a wider range of information delivery to the functional application. For example, the functional application in the mobile terminal is a video greeting application i.e. several users, like friends, have agreed that they can send video greetings to each others through a dedicated functional application in their mobile terminals. In an embodiment of the invention the light-weight video greeting is sent with a multimedia message from a first terminal to a second terminal. Due to some desired additional effects, which the functional application can add to the message content, it is advantageous that the functional application recognizes that a multimedia message relating to that specific functional application is received in the mobile terminal. The functional application is configured to interpret the content of the message, e.g. in this case the video greeting data and additionally some header data when available. As a result of the interpretation of the received multimedia message the functionality of the functional application is instructed i.e. the video greeting is shown immediately in the functional application residing in the mobile terminal.

According to some embodiments of the invention UICC (Universal Integrated Circuit Card) is utilized in the context of delivering information to a functional application in the mobile terminal over mobile telecommunication network. In such embodiments the received message is directed to an application stored in UICC which extracts the necessary information from the received message and based on the extracted information controls the functional application in the mobile terminal. The controlling in this context comprises that UICC applications send at least part of the content of the received message to the functional application located in the mobile terminal. Alternatively or in addition, the UICC application may modify at least part of the content and/or other information received in the form of the message, and then delivers the at least partly modified content and/or other information to the functional application in the mobile terminal. For example, in some functional applications it is advantageous to have very high security level of the message. For such a need the telecom operator may offer higher encryption and thus higher level of security by offering the utilization of the features of UICC card, which is an entity fully managed and controlled by the telecom operator and into which one can store additional applications. Thus for example, all security related issues can be solved through an application residing in the UICC, which application is further configured to deliver the necessary information included in the received message and dedicated to the functional application residing in the memory of the user terminal and run with the processing means of the user terminal. Additionally, according to some other embodiments of the invention the whole functional application is implemented in the UICC card. The functional application is stored in the memory of the UICC and the application is run in the UICC card by means of processing means in the UICC card. Only the output devices in the user terminal, such as displaying means, audio means and/or means for creating sensing effects, like vibration, are utilized for outputting the functional application information if applicable.

The above described functional applications implemented in an UICC card can advantageously be utilized in such services, which require high security. Such services can relate to banking, ticketing and/or access control. For example, so called near field communication (NFC) based access control systems may utilize the inventive idea described in such a manner that if the access application is a so called functional application residing in the UICC card of a mobile terminal, any updates relating to access code are advantageously implemented by means of predetermined message over a mobile communication network.

A user terminal 401 according to an embodiment of the current invention is illustrated in FIG. 4. The user terminal comprises memory means 402, such as one or more RAM and/or ROM memory element(s), for storing data, processing means 403, such as one or more processor(s) for processing the stored data, radio communication means 404, such as one or more radio modems implementing a desired radio communication technology, for communicating with a network wirelessly and I/O means 405, such as keyboard, touch screen, display, microphone and/or speaker, for inputting and outputting data. Moreover, the user terminal 401 comprises interfaces for making the different means in the terminal to interoperate with each other. The user terminal 401 according to the invention comprises further means which are configured to receive a message containing data dedicated to a functional application and transmitted at least partly over a mobile communication network in a predetermined message form, means for interpreting 406 the data in the message, and means for instructing 407 a functionality of the functional application on a basis of the data in the message. According to an embodiment of the invention the interpretation of the message and instructing of the functional application are implemented by means of software code run on processing means 403 of the user terminal. According to some other embodiments of the invention the user terminal comprises interfacing means 408 for coupling a smart card 409, such as SIM or UICC, into it and utilizing the smart card 409 resources in interpretation of a received message and instructing the functionality of the functional application. A non-transitory computer readable medium may be used to store non-transitory software code as described.

In some embodiments of the invention the functional application server is configured to send at least part of the data with a predetermined message over a mobile communication network. For example, part of the data dedicated to the functional application is delivered over an IP network and a part of the data is delivered with a predetermined message over a mobile communication network. In such an embodiment the trigger for data delivery over IP network comes from the functional application server. The server is configured to select part of the data, which is to be included into the predetermined message to be sent over a mobile communication network. The sending of a message over the mobile communication network triggers another delivery of data over an IP network. The data received is combined in the functional application residing in the user terminal.

In some examples of the invention the triggering for sending a message by a functional application server comes from an agreement between the user of the terminal and the service provider. In some other examples of the invention the triggering is set by the service provider only, e.g. in security related functional applications. The invention itself does not prevent any other ground for triggering, but is merely open to any similar implementation.

In a system according to an invention of delivering data dedicated to a functional application the system is configured to transmit a message containing data dedicated to a functional application at least partly over a mobile communication network in a predetermined message form. The data in the message is configured to be interpreted by the system and a functionality of the functional application is configured to be instructed on a basis of the data in the message.

Above it is described several communication methods in the context of functional applications. It is generally known that a user terminal may comprise technologies for connecting the terminal to one or multiple network(s). Examples of such technologies can be 3G (3^{rd} Generation) and/or GSM (Global System for Mobile Communications) chips for connecting the terminal to mobile communication networks generally available or WLAN (Wireless Local Area Network) chip for connecting the terminal directly to the wireless local area network. The user terminal can be for example a mobile phone, a tablet device or a laptop computer. In some context one can even count a personal computer (PC) as a mobile terminal, if the connection is arranged wirelessly into the network. This can be achieved e.g. by a wireless modem connected to an USB port of the PC and utilizing at least partly mobile communication network as is the case with other type of mobile terminals too.

1. A method of delivering data dedicated to a functional application, the method comprising:
receiving a message containing data dedicated to a functional application and transmitted at least partly over a mobile communication network in a predetermined message form (301),
interpreting the data in the message (303), and
instructing a functionality of the functional application on a basis of the data in the message (305).

2. A method as recited in claim 1, the method further comprising: recognizing a structure of the message.

3. A method as recited in claim 1, the method further comprising: managing the message as an invisible message.

4. A method as recited in claim 2, wherein the recognition of the structure of the message and the interpretation of the data in the message are performed by the functional application residing in a user terminal.

5. A method as recited in claim 2, wherein the recognition of the structure of the message and the interpretation of the data in the message are performed by the functional application residing in a smart card coupled in a user terminal.

6. A method as recited in claim 5, the method further comprising: delivering an instruction effecting to the functionality of the functional application residing in the user terminal from the smart card coupled in a user terminal.

7. A user terminal (101, 401), comprising:
one or more memory means (402) for storing data,
one or more processing means (403) for processing the stored data,
one or more radio communication means (404) for communicating with a network,
input and output means (405) for inputting and outputting data,
the user terminal is further configured to
receive a message containing data dedicated to a functional application and transmitted at least partly over a mobile communication network in a predetermined message form,
interpret the data in the message, and
instruct a functionality of the functional application on a basis of the data in the message.

8. A user terminal as recited in claim 7, further including a smart card coupled into the user terminal for storing the functional application.

9. A user terminal as recited in claim 8, wherein the smart card is configured to interpret the data in the message.

10. A user terminal as recited in claim 9, wherein the smart card is configured to instruct the functionality of the functional application on the basis of the data in the message.

11. A system of delivering data dedicated to a functional application, the system comprising:
a message containing data dedicated to a functional application is configured to be transmitted at least partly over a mobile communication network in a predetermined message form,
the data in the message is configured to be interpreted, and
a functionality of the functional application is configured to be instructed on a basis of the data in the message.
